(19) United States
(12) Patent Application Publication
(10) Pub. No.: US 2009/0052114 A1
(43) Pub. Date: Feb. 26, 2009

(54) MULTILAYER ELECTRONIC COMPONENT AND METHOD FOR MANUFACTURING THE SAME

(75) Inventors: Akihiro MOTOKI, Fukui-shi (JP); Makoto OGAWA, Fukui-shi (JP); Yuji UKUMA, Echizen-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/263,556

(22) Filed: Nov. 3, 2008

Related U.S. Application Data
(63) Continuation-in-part of application No. PCT/JP2007/063019, filed on Jun. 28, 2007.

(30) Foreign Application Priority Data
Aug. 22, 2006 (JP) 2006-225278

(51) Int. Cl. H01G 4/228; B05D 5/12; C25D 5/02

(52) U.S. Cl. 361/306.3; 427/77; 205/122

(57) ABSTRACT

A multilayer electronic component includes a base body, internal electrodes disposed inside the base body and extending to exterior surfaces thereof, and terminal electrodes provided on the exterior surfaces of the base body and connected to the internal electrodes. The terminal electrodes include first electrode layers defined by plating layers, and preferably electroplating layer, and second electrode layers made of a conductive resin and provided on the first electrode layers.

### BACKGROUND OF THE INVENTION

1. Field of the Invention

The present invention relates to a multilayer electronic component and a method for manufacturing the same, and more particularly, to a method for forming terminal electrodes of a multilayer electronic component.

2. Description of the Related Art

Conventionally, a multilayer electronic component defined by a multilayer ceramic capacitor includes a base body made of a dielectric substance, internal electrodes provided therein, and terminal electrodes connecting the internal electrodes.

This multilayer electronic component is often surface-mounted on a substrate, such as a circuit substrate. In this case, the terminal electrodes and the substrate are bonded and fixed to each other by soldering. However, when the substrate is warped, a stress is applied to the multilayer electronic component mounted thereon. As a result, the electrical properties of the multilayer electronic component may be degraded and cracks may be generated in the multilayer electronic component.

Accordingly, recently, to reduce the stress caused by substrate warping, the flexibility of the terminal electrode has been increased. In particular, a conductive resin has been used for the terminal electrode. One example of the multilayer electronic component described above is shown in FIG. 3.

In a multilayer electronic component 21 shown in FIG. 3, layered internal electrodes 25 and 26 are provided inside a base body 22 made of a dielectric substance. The internal electrodes 25 are exposed at an end surface 22a of the base body 22, and the internal electrodes 26 are exposed at the other end surface 22b. Terminal electrodes 27 and 28 are provided on the end surfaces 22a and 22b, respectively. The terminal electrodes 27 and 28 are electrically connected to the internal electrodes 25 and 26, respectively.

Each of the terminal electrodes 27 and 28 include four electrode layers, that is, a first layer to a fourth layer. First electrode layers 27a and 28a are formed by firing a conductive paste including a powdered metal and a glass frit and function to reliably provide electrical connection with the internal electrodes 25 and 26, respectively.

Second electrode layers 27b and 28b each made of a conductive resin are formed on the first electrode layers 27a and 28a, respectively. The second electrode layers 27b and 28b are each formed by the steps of applying a conductive resin to a predetermined location, and then curing the resin at a temperature of approximately 200° C.

Plating layers are formed on the second electrode layers 27b and 28b, as necessary, to facilitate soldering to the substrate. For example, third electrode layers 27c and 28c are plating layers to suppress solder leaching and are made, for example, of Cu or Ni. In addition, fourth electrode layers 27d and 28d are plating layers having high solder wettability and are made, for example, of Sn or Au.

A multilayer ceramic capacitor including a conductive resin defining terminal electrodes as described above is disclosed in Japanese Unexamined Patent Application Publication No. 5-144665.

Recently substrate warping tends to increase because the thickness of the substrate has been reduced. Thus, in the multilayer ceramic capacitor disclosed in Japanese Unexamined Patent Application Publication No. 5-144665, a large stress generated by the substrate warping cannot be sufficiently reduced. In particular, a stress is likely to be concentrated in a curved portion of the terminal electrode, and as a result, cracking is likely to occur in this portion.

In addition, in the multilayer ceramic capacitor disclosed in the Japanese Unexamined Patent Application Publication No. 5-144665, since the first electrode layer is formed by firing a conductive paste, in order to ensure bonding reliability with internal electrodes, the thickness of the first electrode layer is increased. As a result, there is a problem in that an effective volume ratio of the multilayer ceramic capacitor is decreased.

### SUMMARY OF THE INVENTION

To overcome the problems described above, preferred embodiments of the present invention provide a multilayer electronic component and a method for manufacturing the same, the multilayer electronic component having an improved effect of reducing a stress caused by substrate warping, suppressing the deterioration of the electrical properties and the generation of cracks, and having a high effective volume ratio.

A multilayer electronic component according to a preferred embodiment of the present invention includes a base body made of a dielectric substance, a plurality of internal electrodes disposed inside the base body and extending to exterior surfaces thereof, and terminal electrodes provided on the exterior surfaces of the base body and connected to the internal electrodes, in which the terminal electrodes include first electrode layers defined by plating layers and second electrode layers each made of a conductive resin and provided on the first electrode layers.

Preferably, the plating layers are electroplating layers.

The terminal electrodes preferably further include third electrode layers, which are provided on the second electrode layers and defined by plating layers.

When the multilayer electronic component according to preferred embodiments of the present invention is manufactured, a method for manufacturing a multilayer electronic component according to a preferred embodiment of the present invention includes the steps of preparing the base body, and forming the terminal electrodes on the exterior surfaces of the base body, in which in the step of forming the terminal electrodes, plating is performed directly on portions of the internal electrodes that are exposed at the exterior surfaces of the base body so that plating films formed on the exposed portions are grown and connected to each other to form the first electrode layers, and each of the second electrode layers are made of a conductive resin and formed on the first electrode layers.

The plating is preferably electroplating.

In addition, in the method for manufacturing a multilayer electronic component according to this preferred embodiment of the present invention, at the surfaces at which the internal electrodes are exposed, the distance between adjacent internal electrodes among the internal electrodes is preferably about 50 μm or less, and a withdrawal length of each of the internal electrodes from each of the exterior surfaces is preferably about 1 μm or less.

The method for manufacturing a multilayer electronic component according to this preferred embodiment of the present invention preferably further includes the step of, before the first electrode layers are formed, polishing the base body using a polishing agent.

Since the first electrode layers formed by plating, and preferably electroplating, are provided as underlayers for the second electrode layers made of a conductive resin, an effect of reducing stress generated by substrate warping is significantly improved, and deteriorations in the electrical properties and defects, such as cracks, can be reliably suppressed.

In addition, since the first electrode layers are formed by plating, the thickness of each of the terminal electrodes can be decreased, and the effective volume ratio of the multilayer electronic component can be improved.

Furthermore, since the first electrode layers are directly formed on the exposed surfaces of the internal electrodes by plating, a dipping step or a firing step is not required, and the manufacturing process can be simplified, accordingly.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view of a multilayer electronic component according to a preferred embodiment of the present invention.

FIGS. 2A and 2B include views illustrating a test method for evaluating an anti-warping property of a multilayer electronic component according to a preferred embodiment of the present invention.

FIG. 3 is a cross-sectional view of a conventional multilayer electronic component.

### DETAILED DESCRIPTION OF PREFERRED EMBODIMENTS

A multilayer electronic component according to preferred embodiments of the present invention will be described. An example of a multilayer electronic component according to a preferred embodiment of the present invention is shown in FIG. 1.

According to FIG. 1, a multilayer electronic component 1 according to a preferred embodiment of the present invention includes a base body 2 made of a dielectric substance, a plurality of internal electrodes 5, and a plurality of internal electrodes 6 disposed in the base body 2, and terminal electrodes 7 and 8 electrically connected to the internal electrodes 5 and 6, respectively. The internal electrodes 5 extend to an exterior surface of the base body, that is, to an end surface 2a. The terminal electrode 7 is provided on the end surface 2a. In addition, the internal electrodes 6 extend to the other end surface 2b of the base body. The terminal electrode 8 is provided on the end surface 2b.

The dielectric substance defining the base body 2 is not particularly limited as long as it has electrical insulation properties. For example, in a multilayer ceramic capacitor, a barium titanate-based dielectric ceramic has been preferably used.

In addition, in the multilayer electronic component 1 shown in FIG. 1, the base body 2 preferably has a substantially rectangular parallelepiped shape, and the end surfaces 2a and 2b face each other. However, the shape of the base body 2, the locations at which the terminal electrodes are provided, and the number thereof are not particularly limited.

Furthermore, materials for the internal electrodes 5 and 6 are not particularly limited. For example, when Ni, Cu, or other suitable material is used, costs can be reduced.

The terminal electrodes 7 and 8 include first electrode layers 7a and 8a formed by electroplating or electroless plating and second electrode layers 7b and 8b which are formed on the respective first electrode layers and which are made of a conductive resin. By the interaction between the first electrode layers 7a and 8a and the second electrode layers 7b and 8b, the effect of reducing a stress generated by substrate warping is increased as compared to that in the related art.

The first electrode layers 7a and 8a are formed by plating, and electrode layers formed by dry plating are not in the scope of the present invention. For example, layers formed by sputtering, vacuum deposition, metallicon, or other dry plating methods are inferior in reducing a stress generated by substrate warping. In addition, the humidity resistance is also disadvantageously decreased due to a reduced compactness. Electroplating is preferable to electroless plating to reduce a stress generated by substrate warping.

In addition, a metal species forming the first electrode layers 7a and 8a is not particularly limited as long as the effect of reducing a stress generated by substrate warping is not diminished. However, for example, Cu or Ni is preferably used since the humidity resistance is improved thereby.

Furthermore, to improve the effective volume ratio, the first electrode layers 7a and 8a are preferably connected to the respective internal electrodes without any layers interposed therebetween. In addition, the thicknesses of the first electrode layers 7a and 8a can be decreased to approximately 10 μm or less, and the thicknesses thereof are preferably decreased to as small as possible without diminishing the stress reducing effect.

The second electrode layers 7b and 8b are made of a conductive resin. The type of conductive resins used is not particularly limited. However, for example, an epoxy resin including Ag filler dispersed therein is preferably used. The second electrode layers 7b and 8b are formed by applying a conductive resin to a predetermined location, followed by performing curing at a temperature of approximately 200° C.

Furthermore, plating layers are preferably formed on the second electrode layers 7b and 8b so as to facilitate soldering. For example, in the multilayer electronic component shown in FIG. 1, in order to suppress solder leaching, third electrode layers 7c and 8c are formed by plating. The third electrode layers 7c and 8c are preferably made of Cu, Ni, or other suitable material, for example. In order to improve solder wettability, fourth electrode layers 7d and 8d are formed on the third electrode layers 7c and 8c, respectively, by plating. The fourth electrode layers 7d and 8d are preferably formed of Sn, Au, or other suitable material, for example.

Subsequently, a method for manufacturing a multilayer electronic component according to a preferred embodiment of the present invention, and in particular, a method for forming the first electrode layers 7a and 8a of the terminal electrodes 7 and 8 will be described.

In accordance with a known method for manufacturing a multilayer capacitor, the base body 2 is prepared. Next, the first electrode layers 7a and 8a are formed by plating. The internal electrodes 5 and 6 are exposed at predetermined intervals at the end surfaces 2a and 2b, on which plating is to be performed, of the base body 2. Thus, the surfaces to be plated do not have uniform electrical conductivity, and instead, having irregular electrical conductivity. As a method for forming a plating layer on the surface to be plated described above, a method has been known in which a catalytic substance is applied in advance to a surface to be plated, and electroless plating is performed thereon. That is, when a substance having a high catalytic function, such as Pd particles, for example, with respect to a reducing agent is applied only to the end surfaces 2a and 2b, and electroless plating is performed, metal films are deposited only on the portions in which the catalytic substance is applied by the effect of the reducing agent.

However, in the method described above, the step of applying the catalytic substance only to the end surfaces 2a and 2b is complicated. Therefore, electroless plating is not preferable.

When plating is performed, plating films are deposited only on the exposed portions. In addition, when the plating is continuously performed, the plating films on the exposed portions grow, and plating films grown on adjacent exposed portions come into contact with each other. When the plating is further continued, exposed portions of the internal electrodes are crosslinked to each other, and as a result, a uniform plating layer is formed.

In the case of electroplating, when a base body of a multilayer electronic component, a conductive medium, and a plating solution including metal ions are charged in a container and are stirred while electricity is supplied thereto, as the number of contacts between the exposed portions of the internal electrodes and the conductive medium increases, plating films are grown on the exposed portions. When the electroplating is continuously performed, plating films deposited on adjacent exposed portions are brought into contact with each other, and the exposed portions of the internal electrodes are crosslinked to each other, so that a uniform electroplating film is formed.

In addition, in order to form a uniform plating layer using plating, the distance between adjacent internal electrodes provided in the base body 2 is preferably about 50 μm or less, for example. In this case, crosslinking by the plating growth can be reliably performed.

In addition, the withdrawal lengths of the exposed portions of the internal electrodes 5 and 6 from the end surfaces 2a and 2b are each preferably about 1 μm or less. In this case, plating deposition is further promoted, and the uniformity of the plating layer formed by crosslinking is improved.

Furthermore, to decrease the withdrawal lengths of the internal electrodes 5 and 6 from the end surfaces 2a and 2b, the base body 2 is preferably polished before the plating is performed. For example, sand blasting or barrel polishing may preferably be performed.

In addition, the protruding length of the exposed portions of the internal electrodes 5 and 6 from the end surfaces 2a and 2b are preferably at least 0.1 μm, for example. In this case, plating deposition is further promoted, and the uniformity of the plating layer formed by crosslinking is further improved.

Heretofore, the terminal electrodes and the formation method thereof have been primarily described. As the multilayer electronic component, a multilayer ceramic capacitor may be described as an example. However, preferred embodiments of the present invention may also be applied to a multilayer chip inductor, a multilayer chip thermistor, a multilayer piezoelectric element, and other suitable electronic component, for example.

Examples of the multilayer electronic component and the manufacturing method thereof according to preferred embodiments of the present invention will be described.

### Example 1

As shown in FIG. 1, a multilayer ceramic base body was prepared and which had an approximately rectangular parallelepiped shape of about 3.2 mm long, about 1.6 mm wide, and about 1.6 mm thick. The base body was made of a titanium barium-based dielectric ceramic, and internal electrodes were made of Ni. In addition, the thickness of one dielectric layer between adjacent internal electrodes was about 4.4 μm, the number of lamination layers provided for the desired electrostatic capacitance was about 263, and the internal electrodes were alternately exposed at two opposed end surfaces. In addition, at this stage, withdrawal lengths d of the internal electrodes with respect to the surfaces 2a and 2b at which the internal electrodes were exposed were a maximum of about 10 μm.

Sand blasting was performed on the multilayer ceramic base body, and the withdrawal lengths d of the internal electrodes with respect to the surfaces at which the internal electrodes were exposed were set to a maximum of about 0.1 μm.

Next, after about 1000 multilayer ceramic base bodies and about 80 cc of an Fe-made medium having a diameter of about 2 mm and coated with Sn were charged in a horizontal rotating barrel having a volume of about 300 cc, electrolytic Cu strike plating was performed on the surfaces of the multilayer ceramic base bodies at which the internal electrodes were exposed under the following Cu plating conditions, and subsequently, thick electrolytic Cu plating was performed. As a result, first electrode layers made of a Cu plating layer and having a total thickness of about 10 μm were obtained.

### Conditions of Electrolytic Cu Strike Plating

Plating bath: Aqueous solution including about 14 g/L of copper pyrophosphate, 10 g/L of pyrophosphoric acid, and about 10 g/L of potassium oxalate

Temperature: about 25° C.

pH: about 8.5

Rotation speed: about 10 rpm

Power supply: current density of about 0.11/dm² for 60 minutes

### Conditions of Thick Electrolytic Cu Plating

Plating bath: Pyrobright Process manufactured by C. Uyemura & Co. Ltd.

Temperature: about 55° C.

pH: about 8.8

Rotation speed: about 10 rpm

Power supply: current density of about 0.30/dm² for about 60 minutes

Next, powdered Ag, an epoxy resin, and a phenol resin were mixed together so as to obtain about 80 percent by weight of the powdered Ag, and butyl carbitol was added as a solvent, so that a conductive resin composition including the powdered Ag as filler was prepared.

In the multilayer ceramic base body provided with the first electrode layers, the conductive resin composition was applied to the first electrode layers by a dipping method. In addition, the conductive resin composition was cured at about 200° C. for about 30 minutes. As a result, second electrode layers made of the conductive resin and having a thickness of about 100 μm were obtained.

Next, after about 1000 multilayer ceramic base bodies provided with the second electrode layers and about 80 cc of an Fe-made medium having a diameter of about 2 mm and coated with Sn were charged in a horizontal rotating barrel having a volume of about 300 cc, electrolytic Ni plating was performed on the second electrode layers under the following Ni plating conditions. As a result, third electrode layers made of a Ni plating layer and having a thickness of about 4 μm were obtained.

### Conditions of Electrolytic Ni Plating

Plating bath: Watt bath

Temperature: about 60° C.

pH: about 4.2

Rotation speed: about 10 rpm

Power supply: current density of about 0.20/dm² for about 60 minutes

Furthermore, after about 1000 multilayer ceramic base bodies provided with the third electrode layers and about 80 cc of an Fe-made medium having a diameter of about 2 mm and coated with Sn were charged in a horizontal rotating barrel having a volume of about 300 cc, electrolytic Sn plating was performed on the third electrode layers under the following Sn plating conditions. As a result, fourth electrode layers made of a Sn plating layer and having a thickness of about 4 μm were obtained.

### Conditions of Electrolytic Sn Plating

Plating bath: Sn-235 manufactured by Dipsol Chemicals Co., Ltd.

Temperature: about 33° C.

pH: about 5.0

Rotation speed: about 10 rpm

Power supply: current density of about 0.10/dm² for about 60 minutes

Using the steps described above, the terminal electrodes each including the first to the fourth electrode layers were formed, so that samples of the multilayer ceramic capacitors were obtained. Next, an evaluation of an anti-warping property and that of high-temperature and high-humidity load reliability will be described.

A sample 1 of the multilayer ceramic capacitor was mounted on a primary surface of a glass epoxy substrate 11 having a long side of about 100 mm, a short side of about 40 mm, and a thickness of about 1.6 mm by using 63Sn-37Sb eutectic solder so that the long side of the substrate 11 and the long side of the sample 1 were substantially parallel to each other.

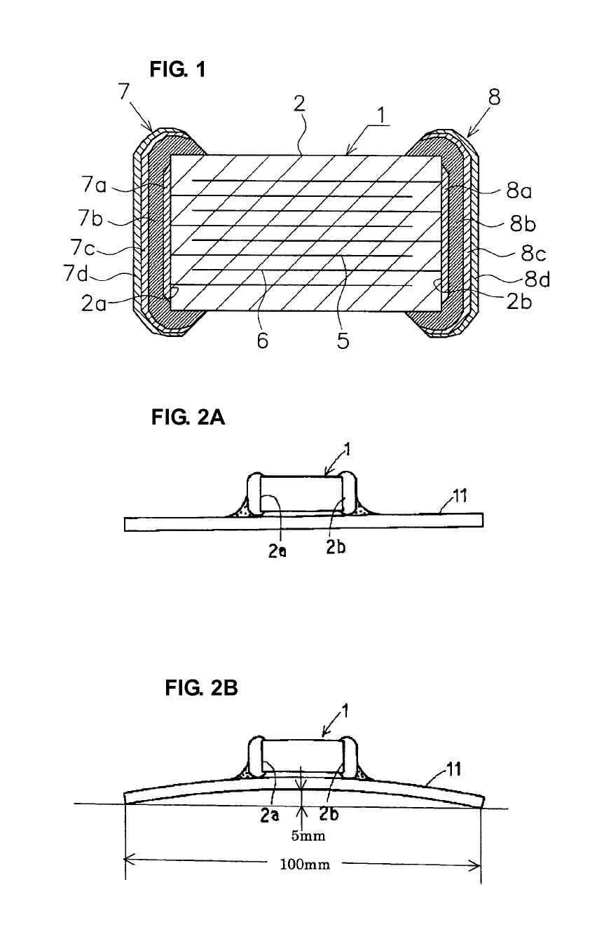

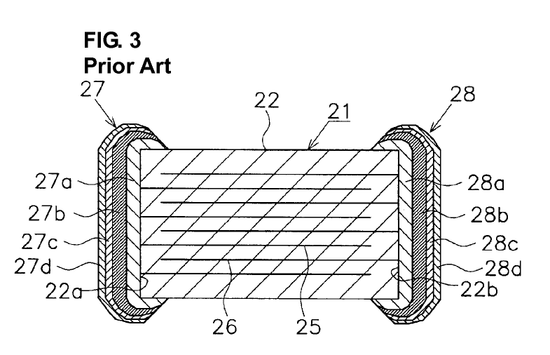

Next, as shown in FIG. 2B, in accordance with JIS C 60068-2-21, while portions in the vicinity of the two short sides of the substrate 11 were held, the substrate 11 was warped such that a portion thereof on which the sample 1 was mounted had a convex shape having a height of about 5 mm, and this state was maintained for about 5 seconds. Subsequently, the occurrence of cracks on a polished cross-sectional surface of the sample 1 was observed by a microscope. Even when only one crack was present, the sample was regarded as a defective. This warping test was performed on about 20 samples.

In addition, about 20 samples of the multilayer ceramic capacitors were subjected for about 144 hours to conditions in which the temperature was about 125° C., the humidity was about 95%, and a voltage of about 16 V (rated voltage) was applied thereto. Any sample having an insulating resistance of about 10⁶Ω or less was regarded as a defective.

### Comparative Example 1

Powdered Cu, an acrylic resin, and a glass frit were mixed together in ethylene glycol/butyl ether, which were used as an organic solvent, so that a Cu paste was obtained. This Cu paste was applied to the end surfaces of the multilayer ceramic base body that is substantially identical to that in Example 1 at which the internal electrodes were exposed by a dipping method and was then fired in a nitrogen atmosphere at about 800° C. Accordingly, first electrode layers made of fired Cu electrodes having a thickness of about 50 μm were formed.

Next, using substantially the same steps as those in Example 1, the second to the fourth electrode layers were formed to obtain the terminal electrodes, so that a sample of the multilayer ceramic capacitor was obtained. In addition, under the same conditions as those in Example 1, the anti-warping property and the high-temperature and high-humidity load reliability were evaluated.

### Comparative Example 2

After a multilayer ceramic base body substantially identical to that in Example 1 was prepared, a metal mask was provided thereon, and Cu sputtering was performed on the end surfaces at which the internal electrodes were exposed. Accordingly, first electrode layers made of sputtered Cu films having a thickness of about 10 μm were formed.

Next, using substantially the same steps as those in Example 1, the second to the fourth electrode layers were formed to obtain the terminal electrodes, so that a sample of the multilayer ceramic capacitor was obtained. In addition, under the same conditions as those in Example 1, the anti-warping property and the high-temperature and high-humidity load reliability were evaluated.

The results of the anti-warping property and the high-temperature and high-humidity load reliability obtained in Example 1 and Comparative Examples 1 and 2 are shown in Table 1.

TABLE 1

| | Anti-Warping Test | High-Temperature and |
|---|---|---|
| | Number of | High-Humidity Load Test |
| | Defectives | Number of Defectives |
| Example 1 | 0/20 | 0/20 |
| Comparative | 10/20 | 0/20 |
| Example 1 | | |
| Comparative | 4/20 | 12/20 |
| Example 2 | | |

As described above, the first electrode layers which were provided as an underlayer for the conductive resin were formed by three processes, that is, plating, paste firing, and sputtering and were then compared to each other. As a result, when the plating method was used, the lowest warping rejection rate was obtained. In addition, it was determined that since the density of the plating was relatively high, the high-temperature and high-humidity load reliability was also improved.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A multilayer electronic component comprising:
a base body defined by a dielectric substance;
a plurality of internal electrodes disposed inside the base body and extending to exterior surfaces thereof; and
terminal electrodes provided on the exterior surfaces of the base body and connected to the internal electrodes; wherein
each of the terminal electrodes includes a first electrode layer define by a plating layer and a second electrode layer made of a conductive resin and provided on the first electrode layers.

2. The multilayer electronic component according to claim 1, wherein the plating layer is an electroplating layer.

3. The multilayer electronic component according to claim 1, wherein each of the terminal electrodes further includes a third electrode layer provided on the second electrode layers and defined by a plating layer.

4. A method for manufacturing a multilayer electronic component, comprising the steps of:
preparing a base body defined by a dielectric substrate and including a plurality of internal electrodes disposed inside the base body and extending to exterior surfaces thereof; and
forming terminal electrodes on the exterior surfaces of the base body; wherein
in the step of forming the terminal electrodes, plating is performed directly on exposed portions of the internal electrodes exposed at the exterior surfaces of the base body such that plating films formed on the exposed portions are grown and connected to each other to form first electrode layers; and
in the step of forming the terminal electrodes, second electrode layers made of a conductive resin are formed on the first electrode layers.

5. The method for manufacturing the multilayer electronic component according to claim 4, wherein, at the exterior surfaces at which the internal electrodes are exposed, a distance between adjacent internal electrodes among the plurality of internal electrodes is about 50 μm or less, and a withdrawal length of each of the plurality of internal electrodes from each of the exterior surfaces is about 1 μm or less.

6. The method for manufacturing the multilayer electronic component according to claim 5, further comprising the step of polishing the base body using a polishing agent before the first electrode layers are formed.

7. The method for manufacturing the multilayer electronic component according to claim 4, wherein the plating of the first electrode layers is performed by electrolytic plating.
